(19) United States
(12) Patent Application Publication
(10) Pub. No.: US 2016/0268888 A1
(43) Pub. Date: Sep. 15, 2016

(54) METHOD FOR WRITING STATUS DATA, COMPUTER PROGRAM, COMPUTER PROGRAM PRODUCT, DIGITAL CONTROLLER, POWER CONVERTER, AND BASE STATION

(71) Applicant: TELEFONAKTIEBOLAGET L M ERICSSON (PUBL), Stockholm (SE)

(72) Inventor: Fredrik WAHLEDOW, Färjestaden (SE)

(21) Appl. No.: 14/401,111

(22) PCT Filed: Jan. 14, 2014
(86) PCT No.: PCT/EP2014/050615

§ 371 Date: Nov. 13, 2014

(51) Int. Cl. H02M 3/04; H02M 1/08

(52) U.S. Cl. CPC H02M 3/04; H02M 1/08

(57) ABSTRACT

A method for writing status data regarding the operation of a power converter provided for converting an input voltage to an output voltage and which comprises a digital controller for controlling the operation of the power converter, the digital controller being powered by the input voltage. According to the method status data related to the operation of the power converter are repeatedly received, a measure of the level of the input voltage is repeatedly received, a threshold voltage level is provided, each received measure of the input voltage is compared, upon reception, with the threshold voltage level, and at least some of the status data are written to a non-volatile storage medium when a received measure of the input voltage falls short of the threshold voltage level.

### TECHNICAL FIELD

The technical field relates to digitally controlled power converters.

### BACKGROUND

The arrival of digitally controlled and configurable power converters has open up a vast amount of operating states and fault handling possibilities. If such a power converter shuts down, for any reason, it is virtually impossible to know the cause thereof, unless a hardware component was broken.

Existing solutions use schemes rely on an external host, which store status data on a storage medium such as a flash memory in response to a shut down, by aid of which the reason for the shut down may be found. To constantly store status data on the flash memory is not an option, since this would wear out the flash memory in a short time, since a flash memory has a limited number of write cycles, e.g. typically around 20 000 write cycles.

Another solution is to use hold-up capacitors to keep the power up during storage of the status data, but those are space demanding and expensive and may not be an option in many applications.

It is common that microcontrollers are provided with an in-built feature referred to as “brown out” feature, allowing some actions to be performed before the microcontroller is reset due to low voltage supply. However, the time available will typically be too short to store status data on the flash memory, such that the cause to the shut down can be found by aid of the status data.

### SUMMARY

It is an aim to provide an approach, by which a digital controller of a power converter, which is powered by the input voltage to the power converter, can write status data related to the operation of the power converter to a non-volatile storage medium immediately before any shut down of the power converter—and thus of the digital controller, where the status data can be used for fault detection and analysis purposes, and which approach does not require the use of external hosts or hold-up capacitors.

A first aspect refers to a method for writing status data related to the operation of a power converter provided for converting an input voltage to an output voltage, and which comprises a digital controller for controlling the operation of the power converter, wherein the digital controller is powered by the input voltage. According to the method status data related to the operation of the power converter are repeatedly received, a measure of the input voltage of the input voltage is repeatedly received, a threshold voltage level is provided, each received measure of the input voltage is compared, upon reception, with the threshold voltage level, and at least some of the status data are written to a non-volatile storage medium when a received measure of the input voltage falls short of the threshold voltage level.

When the received measure of the input voltage falls short of the threshold voltage level, this is an indication of an immediately coming shut down of the power converter, and triggers the writing of status data to the non-volatile storage medium. The status data can later be retrieved for failure and analysis purposes similar to that of a black box or flight recorder.

The threshold voltage level, with which each received measure of the input voltage is compared, may be between about 50% and 95%, between about 60% and 90%, or between about 75% and 90% of a nominal level of the input voltage. The threshold voltage level is set as a trade-off between the number of false shut down detections (which decreases with a decreased threshold voltage level) and risk of not having sufficient time for writing the status data to the non-volatile storage medium before the digital controller is reset (which decreases with an increased threshold voltage level).

The logged status data may comprise sensed values of currents, voltages, and/or temperatures; operational parameters; and/or error and/or status codes, such as e.g. total number of operational hours, maximum temperature and its duration, maximum voltage/current sensed, and the nature of the failure, e.g. over voltage, under voltage, or over current.

The status data, which are written to the non-volatile storage medium, may comprise the last logged status data.

Additionally, or alternatively, the at least some of the status data, which are written to the non-volatile storage medium, may comprise the last logged status data, which relates to faultless operation of the power converter.

The power converter may be a DC-DC voltage down-converter, wherein the input and output voltages are less than about 100 V, less than about 60 V, or between about 10 and 50 V. In one example embodiment the DC-DC voltage down-converter is configured to down convert an input voltage of 48 V to an output voltage of 12 V.

The non-volatile storage medium, to which at least some of the status data are written, may be an EEPROM (Electrically Erasable Programmable Read-Only Memory) or a flash memory.

A second aspect refers to a computer program comprising computer program code which, when run on a digital controller, causes the digital controller to perform the method of the first aspect.

A third aspect refers to a computer program product comprising the computer program of the second aspect and a computer readable storage structure, in which the computer program is stored.

A fourth aspect refers to a digital controller having the computer program of the second aspect installed therein.

A fifth aspect refers to a digital controller for controlling the operation of a power converter provided for converting an input voltage to an output voltage. The digital controller is powered by the input voltage and comprises a non-volatile storage medium, a status data logging module, an input voltage monitoring module, and a non-volatile storage medium writing module.

The status data logging module is configured to repeatedly receive status data related to the operation of the power converter and to log the status data. The input voltage monitoring module is configured to repeatedly receive a measure of the level of the input voltage, to compare each received measure of the input voltage, upon reception, with a threshold voltage level, and to indicate when a received measure of the input voltage falls short of the threshold voltage level. The non-volatile storage medium writing module configured to write at least some of the status data to the non-volatile storage medium in response to the input voltage monitoring module indicating that a received measure of the input voltage falls short of the threshold voltage level.

The digital controller may be configured to perform any of the methods or functions as disclosed above with reference to the first aspect.

A sixth aspect refers to a power converter for converting an input voltage to an output voltage comprising the digital controller of the fifth aspect. The power converter may be e.g. a DC-DC voltage down-converter and the input and output voltages may be less than about 100 V, less than about 60 V, or between about 10 and 50 V.

A seventh aspect refers to a base station comprising the power converter of the sixth aspect.

The approach for monitoring input voltage and writing status data to a non-volatile storage medium in response thereto, is efficient, simple, inexpensive, and reliable. Further, it can be software implemented and does not require the use of hold-up capacitors or the space required therefore.

Further characteristics and advantages will be evident from the detailed description of embodiments given hereinafter, and the accompanying FIGS. 1-5, which are given by way of illustration only.

### BRIEF DESCRIPTION OF THE DRAWINGS

FIG. 1 illustrates, schematically, an embodiment of a digitally controlled power converter.

FIG. 2 illustrates, schematically, an embodiment of a digital controller.

FIG. 3 is a schematic flow scheme of an embodiment of a method for writing status data.

FIG. 4 illustrates, schematically, an embodiment of a computer program product.

FIG. 5 illustrates, schematically, an embodiment of a base station.

### DETAILED DESCRIPTION

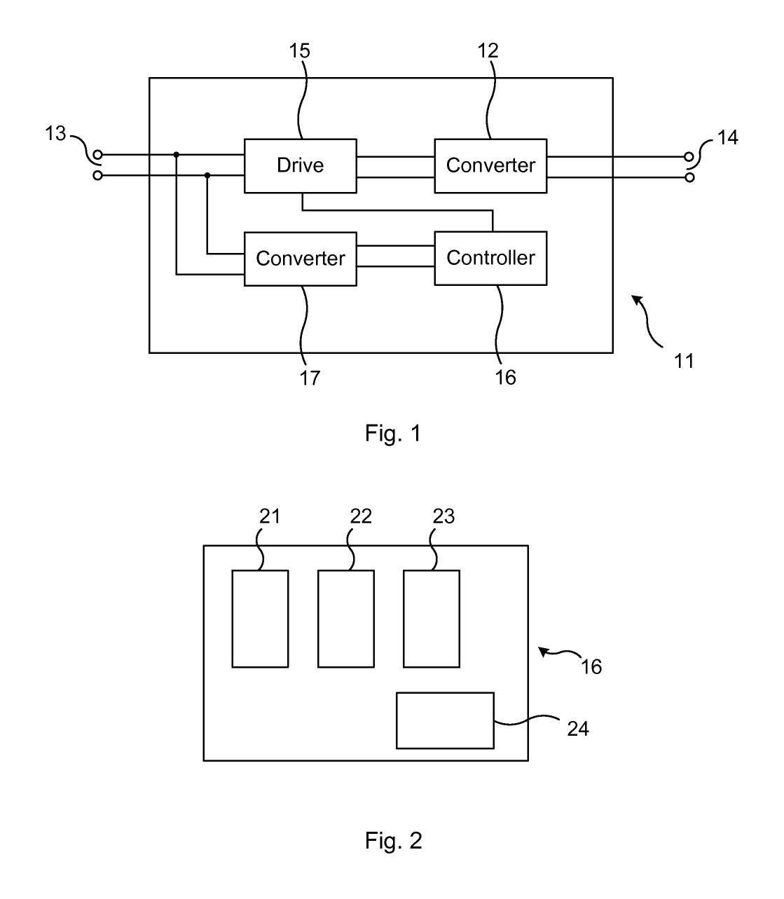

FIG. 1 illustrates, schematically, a digitally controlled power converter 11 comprising a converter 12 for converting an input voltage 13 to an output voltage 14, a drive 15 for driving the converter 12, a digital controller 16 for controlling the drive 15 and thus the operation of the converter 12, and a further converter 17 for down converting the input voltage 13 to a voltage suitable for the digital controller 16, such that the digital controller 16 can be powered by the input voltage 13.

The digitally controlled power converter may be a DC-DC voltage down-converter typically operating with input 13 and output 14 voltages of less than about 100 V, less than about 60 V, or between about 10 and 50 V.

The digital controller 16, which is shown more in detail in FIG. 2, comprises a status data logging module 21, an input voltage monitoring module 22, a non-volatile storage medium writing module 23, and a non-volatile storage medium 24. The status data logging module 21, the input voltage monitoring module 22, and the non-volatile storage medium writing module 23 may be software implemented modules in a microprocessor based digital controller 16.

The non-volatile storage medium 24 is a fast storage medium, which can store data even when the power to the digital controller is off, such as e.g. an EEPROM or a flash memory.

The status data logging module 21 is configured to repeatedly receive status data related to the operation of the power converter 11 and to log these status data. The data may include sensed currents, voltages, and/or temperatures; operational parameters; and/or error and/or status codes.

The input voltage monitoring module 22 is configured to repeatedly receive a measure of the level of the input voltage 13; to compare each received measure of the input voltage 13, upon reception, with a threshold voltage level; and to indicate when a received measure of the input voltage 13 falls short of the threshold voltage level.

The non-volatile storage medium writing module 23 is configured to write at least some of the status data to the non-volatile storage medium 24 in response to the input voltage monitoring module 22 indicating that a received measure of the input voltage 13 falls short of the threshold voltage level. The data written to the non-volatile storage medium 24 may include the last received status data and/or the last received status data, which relates to faultless operation of the power converter 11.

The input voltage monitoring module 22 may be configured to provide the threshold voltage level as lying between about 50% and 95%, between about 60% and 90%, or between about 75% and 90% of a nominal level of the input voltage 13.

By the digital controller 16 disclosed above, status data may be written to a non-volatile storage medium before a shutdown of the power converter and thus the digital controller. The input voltage is monitored and as soon as the input voltage falls below the threshold voltage level, the status data are written to the non-volatile storage medium. The threshold voltage level is selected such that a suitable indication of a shutdown is obtained, while still there should be sufficient time for writing the status data.

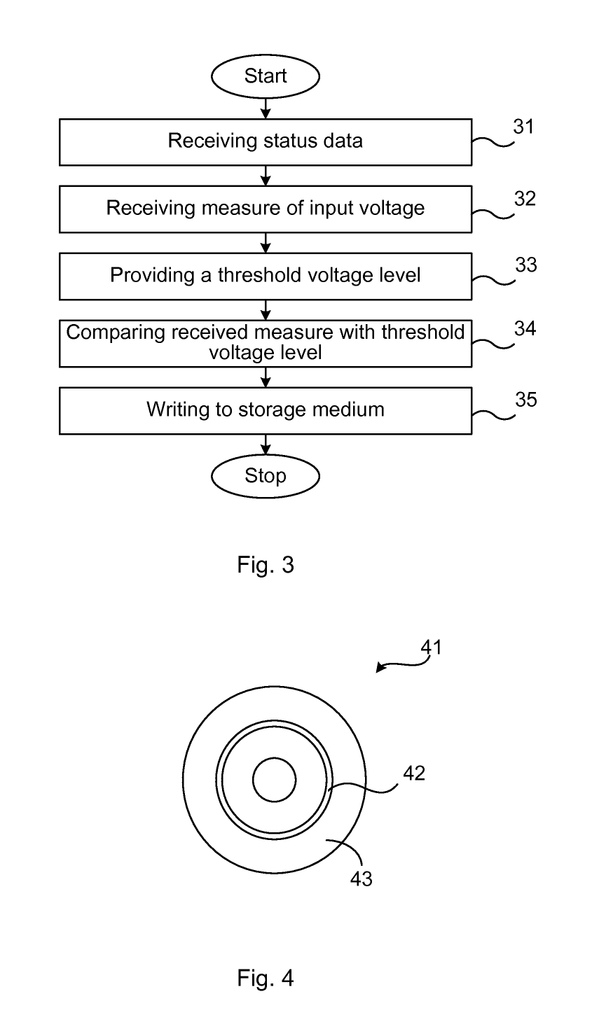

FIG. 3 is a schematic flow scheme of a method for writing status data related to the operation of a power converter provided for converting an input voltage to an output voltage and which comprises a digital controller for controlling the operation of the power converter, wherein the digital controller is powered only by the input voltage. The power converter apparatus may be a DC-DC converter apparatus operating at voltages below 100 V.

According to the method, which is performed in the digital controller, status data related to the operation of the power converter are, in a step 31, repeatedly received. The status data may include data as disclosed with reference to FIGS. 1-2.

A measure of the level of the input voltage is, in a step 32, repeatedly received and a threshold voltage level is in a step 33, provided, e.g. received or retrieved from a memory. Each received measure of the input voltage is, upon reception, in a step 34, compared with the threshold voltage level and at least some of the status data is, in a step 35, written to a non-volatile storage medium when a received measure of the input voltage falls short of the threshold voltage level. The data written to the non-volatile storage medium may be the data disclosed with reference to FIGS. 1-2.

The non-volatile storage medium may be an EEPROM or a flash memory.

The frequency, with which the measure of the level of the input voltage is received, and the level of the threshold voltage may be as disclosed with reference to FIGS. 1-2.

FIG. 4 illustrates, schematically, a computer program product 41, such as e.g. a disc, comprising a computer program 42 and a computer readable structure 43, in which the computer program 42 is stored. The computer program comprises computer program code which, when run on a digital controller, causes the digital controller to perform the method as disclosed with reference to Fig. 3.

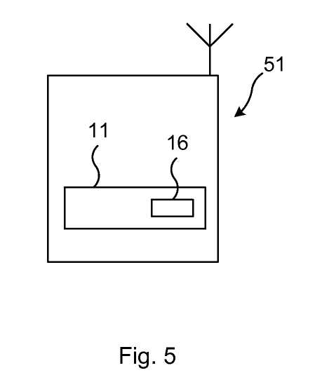

FIG. 5 illustrates, schematically, a base station 51 comprising a power converter 11 provided with a digital controller, wherein the power converter and the digital controller 16 are identical with any of these devices as disclosed above.

It shall be appreciated by a person skilled in the art that the embodiments disclosed herein may be combined to form further embodiments falling within the terms of the claims, and that any details and measures are purely given as examples only.

1. A method for writing status data related to the operation of a power converter provided for converting an input voltage to an output voltage and which comprises a digital controller for controlling the operation of the power converter, the digital controller being powered by the input voltage and the method comprising the following steps being performed in the digital controller:
repeatedly receiving said status data related to the operation of the power converter;
repeatedly receiving a measure of the level of the input voltage;
providing a threshold voltage level;
comparing each received measure of the level of the input voltage, upon reception, with the threshold voltage level; and
writing at least some of said status data to a non-volatile storage medium when one of the received measures of the level of the input voltage falls short of the threshold voltage level.

2. The method of claim 1, wherein the threshold voltage level, with which each received measure of the input voltage is compared, is between about 50% and 95% of a nominal level of the input voltage.

3. The method of claim 1, wherein the power converter, regarding which said at least some of said status data are written, is a DC-DC voltage down-converter.

4. The method of claim 1 wherein the input and output voltages are less than about 100 V.

5. The method of claim 1, wherein said at least some of said status data, which are written to the non-volatile storage medium, comprise values of sensed currents, voltages, and/or temperatures; operational parameters; and/or error and/or error and/or status codes.

6. The method of claim 1, wherein said at least some of said status data, which are written to the non-volatile storage medium, comprise a last received status data.

7. The method of claim 1, wherein said at least some of said status data, which are written to the non-volatile storage medium, comprise a last received status data, which relates to faultless operation of the power converter.

8. The method of claim 1, wherein said non-volatile storage medium, to which said at least some of said status data are written, is an EEPROM or a flash memory.

9. (canceled)

10. (canceled)

11. (canceled)

12. A digital controller for controlling the operation of a power converter provided for converting an input voltage to an output voltage, wherein the digital controller is powered by the input voltage and the digital controller comprises:
a non-volatile storage medium;
a status data logging module configured to repeatedly receive status data related to the operation of the power converter and to log said status data;
an input voltage monitoring module configured to repeatedly receive a measure of the level of the input voltage; to compare each received measure of the level of the input voltage, upon reception, with a threshold voltage level; and to indicate when one of the received measures of the input voltage falls short of the threshold voltage level; and
a non-volatile storage medium writing module configured to write at least some of said status data to the non-volatile storage medium in response to the input voltage monitoring module indicating that said one of the received measures of the input voltage falls short of the threshold voltage level.

13. The digital controller of claim 12, wherein the non-volatile storage medium writing module is configured to provide the threshold voltage level as lying between about 50% and 95%, of a nominal level of the input voltage.

14. The digital controller of claim 12, wherein said at least some of said status data comprise sensed values of currents, voltages, and/or temperatures; operational parameters; and/or error and/or status codes.

15. A power converter for converting an input voltage to an output voltage comprising:
a digital controller for controlling the operation of the power converter, wherein the digital controller is powered by the input voltage and the digital controller includes:
a non-volatile storage medium;
a status data logging module configured to repeatedly receive status data related to the operation of the power converter and to log said status data;
an input voltage monitoring module configured to repeatedly receive a measure of the level of the input voltage; to compare each received measure of the level of the input voltage, upon reception, with a threshold voltage level; and to indicate when one of the received measures of the input voltage falls short of the threshold voltage level; and
a non-volatile storage medium writing module configured to write at least some of said status data to the non-volatile storage medium in response to the input voltage monitoring module indicating that said one of the received measures of the input voltage falls short of the threshold voltage level.

16. The power converter of claim 15 wherein the power converter is a DC-DC voltage down-converter and the input and output voltages are less than about 100 V.

17. A base station comprising:
a power converter for converting an input voltage to an output voltage, wherein the power converter includes:
a digital controller for controlling the operation of the power converter, wherein the digital controller is powered by the input voltage and the digital controller includes:
a non-volatile storage medium;
a status data logging module configured to repeatedly receive status data related to the operation of the power converter and to log said status data;
an input voltage monitoring module configured to repeatedly receive a measure of the level of the input voltage; to compare each received measure of the level of the input voltage, upon reception, with a threshold voltage level; and to indicate when one of the received measures of the input voltage falls short of the threshold voltage level; and
a non-volatile storage medium writing module configured to write at least some of said status data to the non-volatile storage medium in response to the input voltage monitoring module indicating that said one of the received measures of the input voltage falls short of the threshold voltage level.

18. The method of claim 1, wherein the threshold voltage level, with which each received measure of the input voltage is compared, is between about 60% and 90% of a nominal level of the input voltage.

19. The method of claim 18, wherein the threshold voltage level is between about 75% and 90% of a nominal level of the input voltage.

20. The method of claim 4, wherein the input and output voltages are less than about 60 V.

21. The method of claim 20, wherein the input and output voltages are between about 10 V and 50 V.

22. The digital controller of claim 12, wherein the non-volatile storage medium writing module is configured to provide the threshold voltage level as lying between about 60% and 90% of a nominal level of the input voltage.

23. The digital controller of claim 22, wherein the non-volatile storage medium writing module is configured to provide the threshold voltage level as lying between about 75% and 90% of a nominal level of the input voltage.

24. The power converter of claim 15, wherein the power converter is a DC-DC voltage down-converter and the input and output voltages are less than about 60 V.

25. The power converter of claim 24, wherein the input and output voltages are between about 10 V and 50 V.

26. A non-transitory machine-readable storage medium having instructions stored therein, which when executed by a processor, causes the processor to perform operations comprising:
repeatedly receiving status data related to the operation of a power converter, wherein the power converter is provided for converting an input voltage to an output voltage;
repeatedly receiving a measure of the level of the input voltage;
providing a threshold voltage level;
comparing each received measure of the level of the input voltage, upon reception, with the threshold voltage level; and
writing at least some of said status data to a non-volatile storage medium when one of the received measures of the level of the input voltage falls short of the threshold voltage level.
